(19) United States
(12) Patent Application Publication
(10) Pub. No.: US 2026/0285455 A1
(43) Pub. Date: Sep. 24, 2026

(54) Underwater ROV-Guided Chemical Injector for Precision Treatment of Aquatic Invasive/Nuisance Species

(71) Applicant: United States of America as Represented by The Secretary of The Army, Alexandria, VA (US)

(72) Inventors: Taylor E. Rycroft, Sherborn, MA (US); Zachariah E. Tomberg, Hanover, NH (US)

(73) Assignee: United States of America as Represented by The Secretary of The Army, Alexandria, VA (US)

(21) Appl. No.: 19/069,195

(22) Filed: Mar. 3, 2025

(51) Int. Cl. B63G 8/00; A01N 61/00; B63C 11/52

(52) U.S. Cl. CPC B63G 8/001; B63C 11/52; A01N 61/00; B63G 2008/005

(57) ABSTRACT

In one embodiment, a system for administering a chemical underwater to treat an underwater target comprises a UROV including a camera and a positioning device and a surface level control device to remotely control the UROV. A tube includes an inlet extending to an outlet of the tube which is attached to the positioning device of the UROV to position the outlet of the tube through which to deliver and dispense the chemical underwater within a field of view of the camera. A driver is configured to drive a medium from the inlet of the tube to the outlet of the tube to move the chemical through the tube to the outlet of the tube.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to remotely operated systems and methods for precisely dispensing chemicals and, more particularly, to underwater systems and methods to dispense liquid, gel, or pelleted chemicals for precision treatment of aquatic invasive/nuisance species.

### Description of the Related Art

This section introduces aspects that may help facilitate a better understanding of the invention. Accordingly, the statements of this section are to be read in this light and are not to be understood as admissions about what is prior art or what is not prior art.

Invasive submerged aquatic vegetation (SAV) is a pervasive ecological threat that causes losses in biodiversity and changes in ecosystems, and negatively impacts the economic and recreational sectors. Failure to eradicate even a small patch of invasive SAV can be detrimental to a control program, as many invasive species grow and spread rapidly. Such rapid growth can overwhelm the recovery and conservation of the nation's imperiled plant and animal species listed as threatened or endangered under the Endangered Species Act (ESA). Control programs to reduce or eradicate invasive SAV often utilize chemical herbicide treatment methods which may be restricted in ESA-listed waters or in National Historic Preservation Act (NHPA) culturally sensitive areas because of the direct and indirect impacts these chemicals can have on historic properties and artifacts. These restrictions on chemical control methods are particularly common in areas where limits may be placed on chemical use rates, maximum application areas, or use near historic and culturally sensitive submerged lands.

As a result of these restrictions, it may not be possible to treat small, newly established populations of invasive SAV in the necessary rapid response time, leading to an increased risk of introduction to uninvaded areas. While well-intended to preserve sensitive ecosystems, artifacts, or tribal areas of concern, both ESA and NHPA can lead to a paradoxical result, where invasive SAV are inadvertently left to grow and spread in sensitive areas because they cannot be controlled with current broad-stroke methods, which, in turn, causes out-competition of endangered and threatened species and leads to population decline for these desired species.

### SUMMARY

The control of SAV is much more difficult than the control of emergent aquatic plants (i.e., rooted in the lake bottom but with leaves and stems extending out of the water) for several reasons, three of which are addressed by this invention: 1) the amount of herbicide needed depends on the depth of the water, 2) wind, waves, inflow, outflow and currents dilute herbicides, and 3) submersed weeds are generally much more expensive to treat. To effectively eradicate invasive SAV—particularly in ecologically and culturally sensitive areas where restrictions are imposed by ESA and NHPA—there is a need for a more precise, environmentally compatible chemical treatment method than is currently available for both established and early detection-rapid response (EDRR) operations, and that can mitigate the three barriers listed above.

Embodiments of this invention provide the ability to safely administer spot and/or inject-type chemical treatment with minimal indirect ecosystem impacts in sensitive, ESA-listed or NHPA-listed waters.

According to one embodiment, a system called “DISRUPTR” (Disruption of Invasive Species via Remotely-controlled Underwater Precision Treatment and Remediation) integrates an underwater remotely operated vehicle (UROV) with both a liquid herbicide sprayer and a solid/granular herbicide feeder to alleviate issues related to water column dilution and water exchange processes in small patch treatments and minimize off-target ecosystem and cultural impacts.

To operate, the UROV is navigated to the target underwater plants. The herbicide sprayer, which is topside on a boat or on shore, is turned on to administer either liquid or solid herbicide via a transport hose or tube connected to the UROV. The length of the tube is attached to the tether of the UROV and the end of the tube is affixed to the front of the UROV, so that the operator can watch as the herbicide is dispensed via the UROV live video stream.

An aspect of the present invention is directed to a system for administering a chemical underwater to treat an underwater target. The system comprises a UROV including a camera and a positioning device and a surface level control device to remotely control the UROV. A tube includes an inlet extending to an outlet of the tube which is attached to the positioning device of the UROV to position the outlet of the tube through which to deliver and dispense the chemical underwater within a field of view of the camera. A driver is configured to drive a medium from the inlet of the tube to the outlet of the tube to move the chemical through the tube to the outlet of the tube.

In some embodiments, the driver may comprise an eductor to drive a liquid medium as a driving fluid and the chemical by suction through the tube to the outlet of the tube, and the chemical comprises a gel chemical, a solid chemical, or a liquid chemical. The driver may comprise a compressor to compress a gas medium to form a compressed gas to move the chemical through the tube to the outlet of the tube, and the chemical comprises a solid chemical. The driver may comprise a pump to pump the chemical through the inlet of the tube to the outlet of the tube, and the chemical comprises a liquid chemical or a liquid medium containing a gel chemical. The system may include two or all three of the eductor, the compressor, or the pump.

Another aspect is directed to a method for administering a chemical underwater to treat an underwater target, utilizing a UROV including a camera and a positioning device. The method comprises: connecting an outlet of a tube, which has an inlet above water, to the positioning device of the UROV to position the outlet of the tube; remotely controlling the UROV from a surface level control device on a surface level to move the UROV to an underwater location to place an underwater target within a field of view of the camera; and driving the chemical from the surface level through the tube to the outlet of the tube to deliver and dispense the chemical underwater toward the underwater target within the field of view of the camera.

In some embodiments, driving the chemical may comprise operating an eductor to drive a driving fluid to draw the chemical by suction through the tube to the outlet of the tube. Driving the chemical may comprise compressing a gas to form a compressed gas to move the chemical through the tube to the outlet of the tube. Driving the chemical may comprise pumping a liquid medium containing the chemical through the tube to the outlet of the tube.

In specific embodiments, a solid chemical may be driven by at least one of compressing a gas to form a compressed gas to move the solid chemical through the tube to the outlet of the tube, or operating an eductor to drive a driving fluid to draw the solid chemical by suction through the tube to the outlet of the tube. A liquid chemical may be driven by at least one of pumping the liquid chemical through the tube to the outlet of the tube, or operating an eductor to drive a driving fluid to draw the liquid chemical by suction through the tube to the outlet of the tube. A gel chemical may be driven by at least one of pumping the liquid medium containing the gel chemical through the tube to the outlet of the tube, or operating an eductor to drive a driving fluid to draw the gel chemical by suction through the tube to the outlet of the tube.

Yet another aspect is directed to a system for administering a chemical underwater to treat an underwater target. The system comprises a UROV including a camera and a positioning device and a surface level control device to control remotely the UROV. The system includes either an eductor to drive a driving fluid to draw, by suction, a solid chemical, a liquid chemical, or a gel chemical through an eductor tube to an outlet of the eductor tube through which to deliver and dispense the solid chemical, the liquid chemical, or the gel chemical underwater within the field of view of the camera; or both (i) a compressor to compress a gas to form a compressed gas to move the solid chemical through a compressed gas tube to an outlet of the compressed gas tube through which to deliver and dispense the solid chemical underwater within a field of view of the camera; and (ii) a pump to pump the liquid chemical or a liquid medium containing the gel chemical through a pump tube to an outlet of the pump tube underwater within the field of view of the camera.

In some embodiments, the system includes the eductor and at least one of the compressor or the pump.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 schematically illustrates an example of a system for administering a chemical underwater to chemically treat a target.

FIG. 2A schematically illustrates an example of a fluid pump system for driving chemicals to the UROV.

FIG. 2B schematically illustrates an example of a compressed gas system for driving chemicals to the UROV.

FIG. 2C schematically illustrates an example of an eductor for driving chemicals to the UROV.

FIG. 3 is a schematic view illustrating an example of a hardware architecture for controlling administration of a chemical underwater to chemically treat a target.

FIG. 4 is a flow diagram illustrating an example of a method for administering a chemical underwater to treat an underwater target utilizing a UROV.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

According to one embodiment, an UROV-guided herbicide injector is designed to precisely dispense liquid, gel, or pelleted chemical herbicide formulations in ecologically and culturally sensitive areas and be deployed from a boat or shore. It can also be used for administering other chemical treatments to target non-plant species.

The DISRUPTR offers a unique and novel precision treatment method for control of SAV similar to high-precision capabilities used in terrestrial settings. The apparatus is a UROV-guided herbicide injector that can dispense either liquid or solid chemical herbicide formulations in precise locations around the target plant and be deployed from a boat or shore. The technology alleviates issues related to water column dilution and water exchange processes in small patch treatments and minimizes off-target ecosystem and cultural impacts. The technology offers a more precise, ESA/NHPA-compatible invasive SAV treatment method than is currently available, thereby reducing the risk of invasive SAV spread in environmentally and culturally sensitive waterbodies.

The DISRUPTR integrates a traditional weed control power sprayer with an affordable, customizable, easy-to-use UROV. It may be configured to be consistent with models typically used by certain operators or organizations. The spray hose from the power sprayer is affixed to the tether of the UROV. Top-side control of variable dispersal rates for various herbicide viscosities is facilitated by a modified valve or pump on the power sprayer. Dispersal of solid pellets may be facilitated by either a liquid/solids eductor (for water-based transport in the hose) or a modified sand blaster (for air-based transport in the hose).

An eductor is a jet pump or venturi pump that uses fluid flow to move another fluid or a solid substance. It works by converting the pressure energy of a prime fluid into velocity energy which is used to pump another fluid or transport a solid. The prime fluid enters the eductor through an inlet and flows through a converging section which narrows the cross-sectional area of the flow. This causes the velocity of the prime fluid to increase and the pressure to decrease. Next, the high-velocity, low-pressure prime fluid enters a constricted throat, further increasing its velocity. After the prime fluid exits the throat, it enters a diverging section, where its velocity decreases and its pressure increases. This creates a region of low pressure in the eductor which is used to draw in and pump another fluid or transport a solid. The two fluids or the solid and fluid mixture mix in the diverging section and are discharged from the eductor through an outlet at a distal end of an eductor tube.

A sand blaster has an inlet to a chamber (pressure blast tank or blast pot) and a nozzle at an outlet. Air intake via the inlet into the chamber is powered by an air compressor that applies pressure to media inside the chamber. The air with the media exits the nozzle at the outlet at high speeds and impacts a target with force. The sand blaster embodiment may be created by modifying a commercially available sand blaster.

This invention is unique in that it provides significant precision improvements to current herbicide application techniques, yielding ecological, cost, and safety advantages. From a conservation perspective, the highly focused applicator on the DISRUPTR results in a significant reduction in off-target aquatic organism exposure compared to traditional aquatic herbicide application, which reduces the adverse impacts of non-selective herbicides on native flora and fauna. The lessening of excessive dilution in the water column also enhances exposure time and improves the likelihood that invasive SAV receive the full target dose of herbicide, reducing the risk of development of resistant biotypes of invasive SAV that arise from exposure to diluted/sublethal doses.

The systems and methods of this invention are highly desired in applications that benefit from the ability to safely administer spot and/or inject-type chemical treatment with minimal indirect ecosystem impacts in ESA-listed waters and in historic or NHPA-listed culturally sensitive submerged lands.

The precision enabled by the DISRUPTR also results in significant operational cost-savings, as current aquatic herbicide applications use a large volume of concentrated herbicide to account for the extensive dilution in the water column that occurs during broad-area application. Such quantities can be cost-prohibitive. The precision application of the DISRUPTR avoids unnecessary and excessive herbicide losses to dilution in the water column.

The underwater herbicide application facilitated by the DISRUPTR reduces the likelihood of personnel exposure to the spray or mist vapor that can occur when applying herbicides above-water, thereby reducing the potential for adverse human health effects such as eye, skin, or lung irritation.

### System for Dispensing Chemicals Underwater

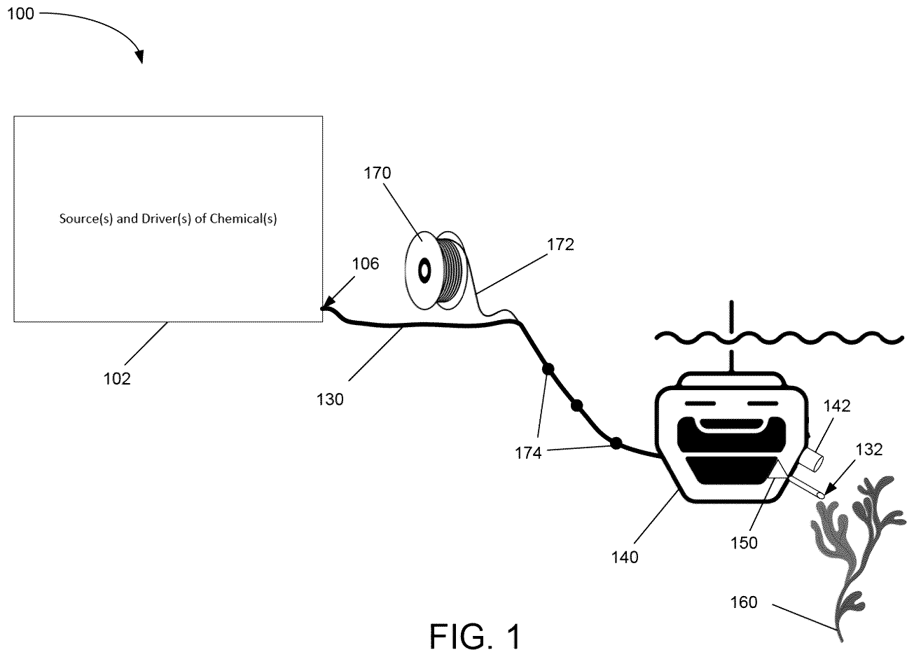

FIG. 1 schematically illustrates an example of a system 100 for administering a chemical underwater to chemically treat a target. The system 100 includes one or more sources of chemicals and one or more drivers 102 to drive a medium to move the chemicals through a transport tube or hose 130 via a tube inlet 106 at a proximal end to a tube outlet 132 at a distal end. A portion of the length of the transport hose 130 is attached to the tether of the UROV 140. The tube outlet 132 at the distal end of the tube 130 is positioned at the front of the UROV 140 where one or more cameras 142 are located. In this way, the operator can watch and observe as the chemical such as an herbicide is dispensed via a UROV live video stream. In one embodiment, the outlet 132 of the tube 130 is affixed to a positioning mechanism 150 in the form of a fixed member mounting device (e.g., a rod or a bar or an angle) to position the outlet 132 at the front of the UROV 140. In other embodiments, the positioning mechanism 150 is configured to move and position the outlet 132 relative to the UROV 140 to aim the delivery of the chemical directly toward a target 160 to make contact with the target 160, such as an invasive submerged aquatic plant or any other underwater target including underwater non-plant species. The chemical is delivered and dispensed underwater within a field of view of the camera 142. The positioning mechanism 150 may be a 3-Dimensional (3D) positioning system or a 3D linear and rotational mechanism. It may include any one or any combination of a linear actuator, a rotary actuator, a rack-and-pinion mechanism, levers, pulleys, gears, cams, and linkages such as a four-bar linkage mechanism.

A tether reel 170 may be provided on a water vessel or the shore to supply the UROV tether 172 to the UROV 140. A distal portion of the tether 172 may be connected to a distal portion of the transport tube 130 by fasteners 174 or the like. The tether 172 can be used to transmit, to the UROV 140, power, data, control signs or commands, and the like.

### Fluid Pump

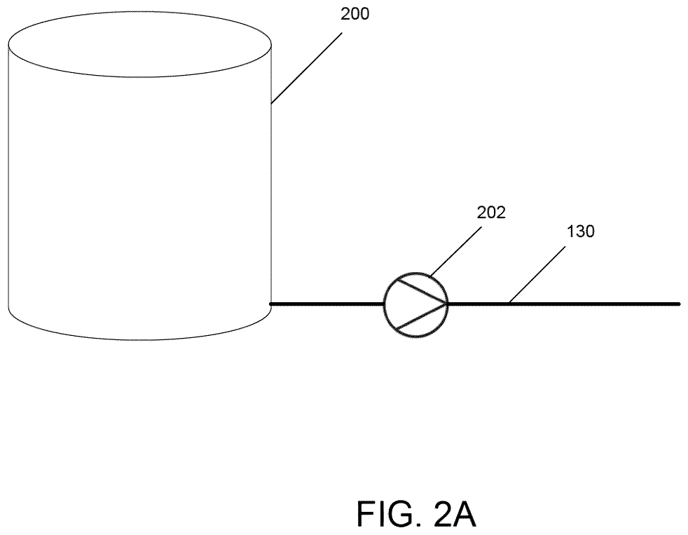

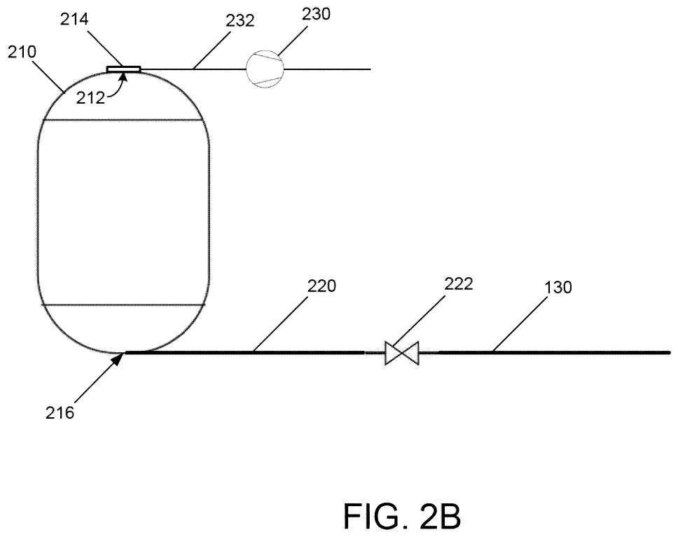

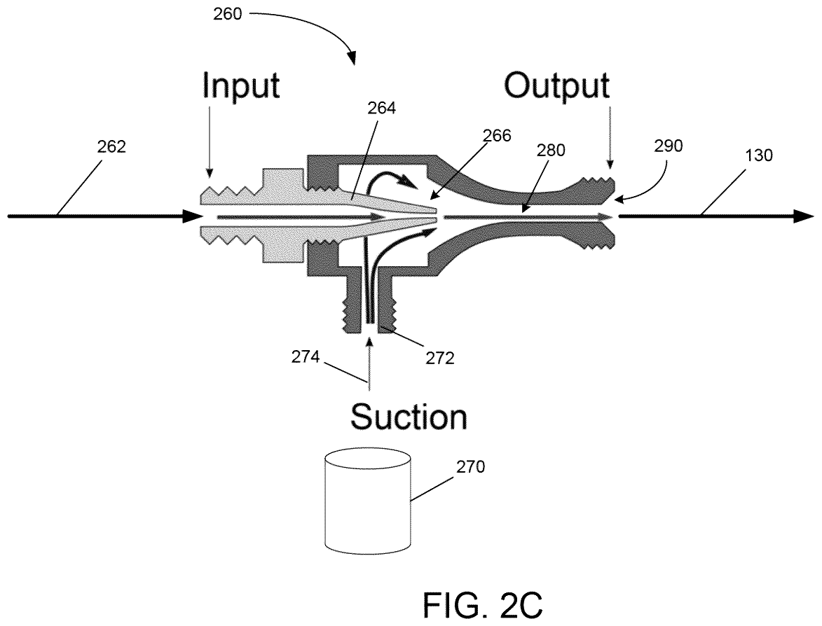

FIG. 2A schematically illustrates an example of a fluid pump system for driving chemicals to the UROV 140. A tank 200 contains a liquid chemical or a liquid medium including a gel chemical. The tank 200 may be disposed on a water vessel or on the shore (or in the ROV). A pump 202 pumps the liquid from the tank 200 via the transport hose or tube 130 to the UROV 140. The pump 120 may be gas or electric or manually powered.

A gel is made up of a network of solid particles suspended in a liquid which allows them to hold their shape while still having some fluidity depending on the pressure applied. The gel is a highly viscous liquid that can be driven to flow by a liquid medium. When a liquid such as water (e.g., from the body of water in which the chemical delivery system operates) is added to the gel, it can disrupt the network of particles, allowing the gel to move more freely. The liquid tank 200 may include the chemical gel and a liquid such as water which may be pumped from the body of water in which the UROV 140 operates.

### Compressed Gas

FIG. 2B schematically illustrates an example of a compressed gas system for driving chemicals to the UROV 140. A tank 210 has an inlet 212 to receive solid chemicals such as pelleted chemicals. A lid 214 covers the inlet 212 to close the tank 210. Compressed air or gas is used to drive the solid chemicals through an outlet 216 to a solids transport hose or tube 220. A valve 222 in the transport tube 220 may be used to regulate the air flow to the transport hose or tube 130. An air compressor 230 may be coupled to the lid 214 to supply the compressed air via an air hose 232. Alternatively, the air compressor 230 may be connected to another part of the tank 210. The tank 210 may be disposed on a water vessel or on the shore (or in the ROV). The tank 210 and the air compressor 230 are configured to operate like a sand blaster and may be formed by modifying a commercially available sand blaster.

### Eductor

FIG. 2C schematically illustrates an example of an eductor 260 for driving chemicals to the UROV 140. From a driving fluid inlet line 262, a driving or motive fluid (usually water which may be drawn from the body of water in which the chemical delivery system operates) enters through a tapering inlet nozzle 264. The driving fluid is driven from a driving fluid pump or some other driving flow source. As the driving fluid exits the inlet nozzle 264, its cross-sectional area decreases, causing a rise in flow velocity. Consequently, there is a decrease in pressure in a low pressure zone 266 due to the Venturi action. In the wake of the low-pressure zone 266 created by the driving fluid, the chemical in a chemical container 270 is drawn in from a separate, suction inlet opening 272 via a suction inlet line 274. For the chemical to be drawn in, the pressure created by the driving fluid in the low pressure zone 266 must be lower than the pressure of the chemical container 270. The chemical is mixed with the driving fluid in a throat section 280, with the mixture gaining kinetic energy. The mixture then moves to a diffuser section 290, where the cross-sectional area increases, causing the velocity to decrease and the pressure energy to increase. The resultant mixture is ejected at a definite outlet to the transport tube 130.

When the driving fluid achieves the desired pressure and capacity, it starts taking suction through the suction side 272. Valves are typically connected to driving fluid inlet line 262, the transport line 130 on the discharge side, and the suction inlet line 274 of the eductor 260. To operate the eductor 260, the first step is to open the driving fluid inlet valve on the driving fluid inlet line 262 and the discharge valve on the transport line 130. The next step is to start the driving fluid pump and regulate the pressure to obtain the necessary capacity for the operation of the eductor 260. The driving pressure varies with the discharge head. The suction valve on the suction inlet line 274 is then opened to take suction from the chemical container 270, only after achieving the desired capacity of driving fluid so as to prevent back flow of driving fluid. Before stopping operation of the eductor 260, a required step is to close the suction valve before the final step of stopping the flow of the driving fluid.

### System Architecture

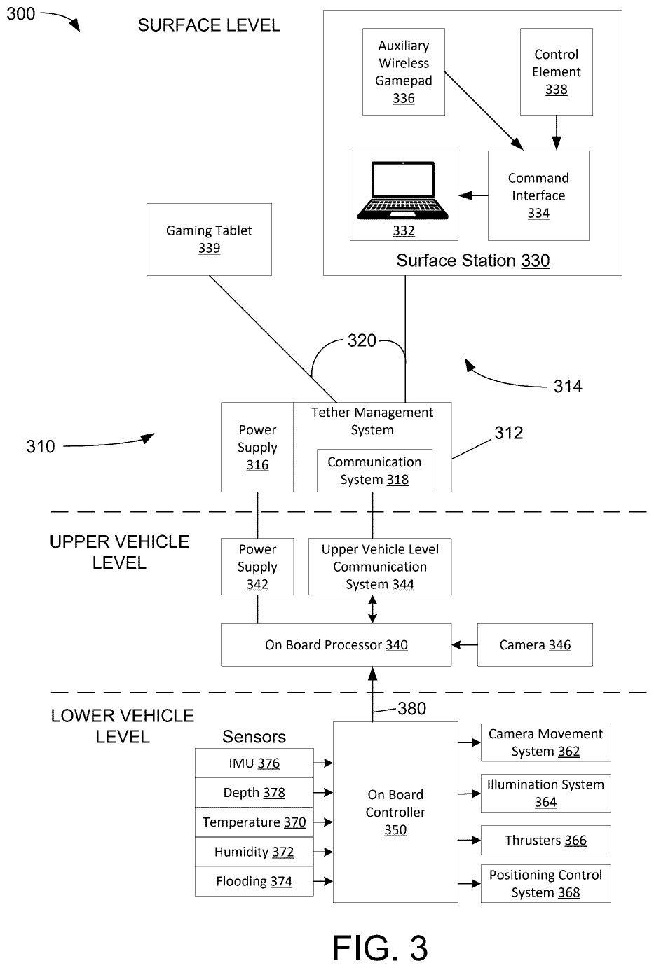

FIG. 3 is a schematic view illustrating an example of a hardware architecture 300 for controlling administration of a chemical underwater to chemically treat a target. The hardware architecture 300 is based on a hierarchical structure with three defined levels: surface level, upper vehicle level, and lower vehicle level. At the high, surface level is a surface control station 310 that has all the components that are located outside the vehicle. The vehicle has a two-layer structure (upper vehicle level and lower vehicle level of the UROV 140), each layer being a centralized subsystem controlled by a respective processing unit.

The surface control station 310 includes a tether management system 312 and an operator interface 314. The tether management system 312 includes a power supply 316 (AC) and optical fiber communication devices 318, for instance. It ensures the power demand of the UROV 140 and communication with the operator's interface 314 which includes a set of tools used by the pilot to command and drive the UROV. Communication between the tether management system 312 and the operator interface 314 may be made through a wireless high speed WiFi link 320. The operator interface 314 may include two operator devices serving as surface level control devices to remotely control the UROV. The first one is a surface station 330 which includes a computer 332 for processing data from the UROV, including video streaming and visualization, a command interface 334, and an auxiliary wireless gamepad 336. The command interface integrates control elements 338, such as joysticks, buttons, indicators, and a Global Positioning System (GPS), that gather information and send it to the computer. The auxiliary wireless gamepad 336 can be connected through the command interface 334 and offers a portable alternative for the main control elements 338. The second operator device may be wholly based on a commercial gaming tablet computer 339, in which a Human-Machine Interface (HMI) can be implemented, allowing one to integrate video stream visualization, touch screen capabilities, analog joysticks, digital buttons, and directional pads in a small, handheld device.

At the upper vehicle level is an on-board computer 340 with power supply 342. It is responsible for data reception from the surface station 330 (or gamepad 336) via an upper vehicle level communication system 344, video acquisition from a high-definition USB web camera 346, processing and streaming acquired images over a TCP/IP network, along with the vehicle status data, and, in short, every high-level processing task that is executed on-board.

At the lower vehicle level is a processing unit or on-board controller 350 which may be a Micro Controller Unit (MCU) running at 84 MHz bus clock. It has direct access to the UROV's devices, such as camera movement system 362, illumination system 364 (e.g., a plurality of high power lights), motor drivers and thrusters 366, positioning control system 368 for controlling the positioning mechanism 150, and sensors, which include fault detection sensors (internal temperature 370, humidity 372, and flooding 374 are measured within the vehicle) and navigation sensors (Inertial Measurement Unit (IMU) 376 and a depth meter 378). A communication link 380 is established between the two vehicle layers to integrate all the UROV devices. This link allows one to treat the hardware system as a single unit. The integration of physical devices may be made through a custom-made circuit board, designed to be compatible with additional components that allow the UROV to extend its functionality. Additional efforts can be made in order to maintain the architecture's flexibility to consider future growth and expansion; specifically, on the UROV instrumentation, e.g., installing underwater positioning devices. The data acquisition system is equipped with appropriate hardware for reading additional sensor measurements, including standard connections used for instrumentation.

### Method for Dispensing Chemicals Underwater

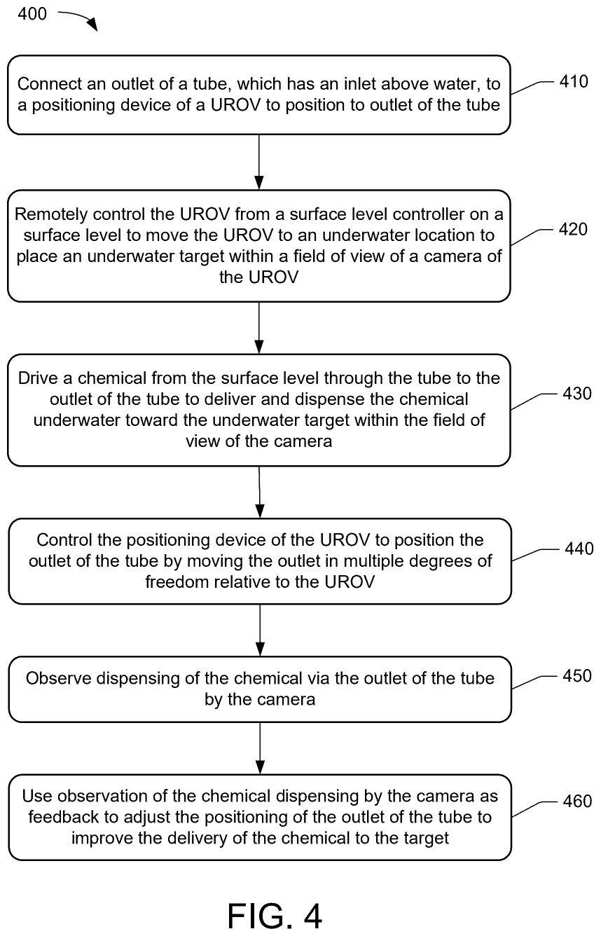

FIG. 4 is a flow diagram 400 illustrating an example of a method for administering a chemical underwater to treat an underwater target utilizing a UROV. Step 410 involves connecting an outlet 132 of a tube 130, which has an inlet above water, to a positioning device 150 of the UROV 140 to position the outlet 132 of the tube 130. In step 420, the UROV 140 is controlled remotely from a surface level control device 330/339 on a surface level to move the UROV to an underwater location to place an underwater target 160 within a field of view of a camera 346 of the UROV. Step 430 involves driving the chemical from the surface level through the tube to the outlet 132 of the tube 130 to deliver and dispense the chemical underwater toward the underwater target 160 within the field of view of the camera 142. In some embodiments, the positioning device 150 is movable to move and position the outlet of the tube. Step 440 involves controlling the positioning device 150 of the UROV 140 to position the outlet 132 of the tube 130 by moving the outlet in multiple degrees of freedom (e.g., at least two or at least three degrees of freedom) relative to the UROV. It may involve using at least one of a linear actuator, a rotary actuator, a rack-and-pinion mechanism, levers, pulleys, gears, cams, or linkages. The chemical may be a chemical herbicide for treating an underwater plant. The underwater target may be an underwater plant with a stalk at a relatively shallow depth of about 15 feet below the surface of the body of water. The positioning of the outlet of the tube may be optimized by trial and error. Step 450 involves using the camera to observe dispensing of the chemical via the outlet of the tube. In step 460, observation of the chemical dispensing by the camera is used as feedback to adjust the positioning of the outlet of the tube to improve the delivery of the chemical to the target.

Embodiments of the invention can be manifest in the form of methods and apparatuses for practicing those methods. The benefits of implementing this technology include the ability to safely administer spot and/or inject-type chemical treatment with minimal indirect ecosystem impacts in ESA-listed waters and in historic or NHPA-listed culturally sensitive submerged lands.

The inventive concepts taught by way of the examples discussed above are amenable to modification, rearrangement, and embodiment in several ways. For instance, outcomes of this research are expected to provide leveraging opportunities to use the chemical delivery system for treatment of invasive mussels (e.g., quagga and zebra) and benthic cyanobacteria at depth or on submerged structures. The chemical may be a molluscicide, a pesticide, an insecticide, or a piscicide for treating an underwater species such as molluscs (e.g., slugs and snails), pests, insects, or invasive fish. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A system for administering a chemical underwater to treat an underwater target, the system comprising:
an underwater remotely operated vehicle (UROV) including a camera and a positioning device;
a surface level control device to remotely control the UROV;
a tube including an inlet extending to an outlet of the tube which is attached to the positioning device of the UROV to position the outlet of the tube through which to deliver and dispense the chemical underwater within a field of view of the camera; and
a driver to drive a medium from the inlet of the tube to the outlet of the tube to move the chemical through the tube to the outlet of the tube.

2. The system of claim 1,
wherein the driver comprises an eductor to drive a liquid medium as a driving fluid and the chemical by suction through the tube to the outlet of the tube; and
wherein the chemical comprises a gel chemical, a solid chemical, or a liquid chemical.

3. The system of claim 1,
wherein the driver comprises a compressor to compress a gas medium to form a compressed gas to move the chemical through the tube to the outlet of the tube; and
wherein the chemical comprises a solid chemical.

4. The system of claim 1,
wherein the driver comprises a pump to pump the chemical through the inlet of the tube to the outlet of the tube; and
wherein the chemical comprises a liquid chemical or a liquid medium containing a gel chemical.

5. The system of claim 1, wherein the driver comprises at least two of:
a compressor to compress a gas medium to form a compressed gas in a compressed gas chamber to move a solid chemical from the compressed gas chamber through the inlet of the tube to the outlet of the tube;
a pump to pump one of a liquid chemical or a liquid medium containing a gel chemical in a liquid container through the tube to the outlet of the tube; or
an eductor to drive a liquid medium to draw one of a solid chemical, a gel chemical, or a liquid chemical by suction, from a chemical container, through the tube to the outlet of the tube.

6. The system of claim 1, comprising all three of:
a compressor to compress a gas medium to form a compressed gas in a compressed gas chamber to move a solid chemical from the compressed gas chamber through the inlet of the tube to the outlet of the tube;
a pump to pump one of a liquid chemical or a liquid medium containing a gel chemical in a liquid container through the tube to the outlet of the tube; or
an eductor to drive a liquid medium to draw one of a solid chemical, a gel chemical, or a liquid chemical by suction, from a chemical container, through the tube to the outlet of the tube.

7. The system of claim 1, wherein the positioning device comprises at least one of:
a mounting device, a 3-Dimensional (3D) positioning mechanism, a linear actuator, a rotary actuator, a rack-and-pinion mechanism, levers, pulleys, gears, cams, or linkages.

8. A method for administering a chemical underwater to treat an underwater target, utilizing an underwater remotely controlled vehicle (UROV) including a camera and a positioning device, the method comprising:
connecting an outlet of a tube, which has an inlet above water, to the positioning device of the UROV to position the outlet of the tube;
remotely controlling the UROV from a surface level control device on a surface level to move the UROV to an underwater location to place an underwater target within a field of view of the camera; and
driving the chemical from the surface level through the tube to the outlet of the tube to deliver and dispense the chemical underwater toward the underwater target within the field of view of the camera.

9. The method of claim 8,
wherein driving the chemical comprises operating an eductor to drive a driving fluid to draw the chemical by suction through the tube to the outlet of the tube.

10. The method of claim 8,
wherein driving the chemical comprises compressing a gas to form a compressed gas to move the chemical through the tube to the outlet of the tube.

11. The method of claim 8,
wherein driving the chemical comprises pumping a liquid medium containing the chemical through the tube to the outlet of the tube.

12. The method of claim 8, wherein the chemical comprises a solid chemical which is driven by at least one of:
compressing a gas to form a compressed gas to move the solid chemical through the tube to the outlet of the tube; or
operating an eductor to drive a driving fluid to draw the solid chemical by suction through the tube to the outlet of the tube.

13. The method of claim 8, wherein the chemical comprises a liquid chemical which is driven by at least one of:
pumping the liquid chemical through the tube to the outlet of the tube; or
operating an eductor to drive a driving fluid to draw the liquid chemical by suction through the tube to the outlet of the tube.

14. The method of claim 8, wherein the chemical comprises a gel chemical which is driven by at least one of:
pumping the liquid medium containing the gel chemical through the tube to the outlet of the tube; or
operating an eductor to drive a driving fluid to draw the gel chemical by suction through the tube to the outlet of the tube.

15. The method of claim 8, further comprising:
controlling the positioning device of the UROV to position the outlet of the tube by moving the outlet in a plurality of degrees of freedom relative to the UROV.

16. The method of claim 8, further comprising:
observing dispensing of the chemical underwater toward the underwater target; and
adjusting a position of the outlet of the tube based on observation of the dispensing of the chemical underwater as feedback to improve delivery of the chemical toward the underwater target.

17. The method of claim 8, further comprising:
directing a chemical herbicide as the chemical toward an underwater plant.

18. The method of claim 8, further comprising:
directing at least one of a molluscicide, a pesticide, an algaecide, an insecticide, or a piscicide as the chemical toward an underwater species.

19. A system for administering a chemical underwater to treat an underwater target, the system comprising:
an underwater remotely controlled vehicle (UROV) including a camera and a positioning device;
a surface level control device to control remotely the UROV; and
an eductor to drive a driving fluid to draw, by suction, a solid chemical, a liquid chemical, or a gel chemical through an eductor tube to an outlet of the eductor tube through which to deliver and dispense the solid chemical, the liquid chemical, or the gel chemical underwater within the field of view of the camera; or both (i) a compressor to compress a gas to form a compressed gas to move the solid chemical through a compressed gas tube to an outlet of the compressed gas tube through which to deliver and dispense the solid chemical underwater within a field of view of the camera; and (ii) a pump to pump the liquid chemical or a liquid medium containing the gel chemical through a pump tube to an outlet of the pump tube underwater within the field of view of the camera.

20. The system of claim 19, comprising:
the eductor and at least one of the compressor or the pump.
